(19) United States
(12) Patent Application Publication
(10) Pub. No.: US 2023/0292267 A1
(43) Pub. Date: Sep. 14, 2023

(54) METHOD FOR DETERMINING SYNCHRONIZATION SIGNAL BLOCK, TERMINAL DEVICE, AND NETWORK DEVICE

(71) Applicant: GUANGDONG OPPO MOBILE TELECOMMUNICATIONS CORP,. LTD., Dongguan (CN)

(72) Inventor: Chuanfeng HE, Dongguan (CN)

(73) Assignee: GUANGDONG OPPO MOBILE TELECOMMUNICATIONS CORP,. LTD., Dongguan (CN)

(21) Appl. No.: 18/320,488

(22) Filed: May 19, 2023

Related U.S. Application Data
(63) Continuation of application No. PCT/CN2018/117308, filed on Nov. 23, 2018.

(51) Int. Cl. H04W 56/00

(52) U.S. Cl. CPC H04W 56/0015; H04W 56/0035

(57) ABSTRACT

Embodiments of the present application relate to a method for determining a synchronization signal block (SSB), a terminal device, and a network device. The method includes receiving a first SSB, the first SSB including first location indication information, and the first position indication information being used for determining a position of a second synchronization raster in a target synchronization raster set, and the target synchronization raster set including part of synchronization rasters in a frequency domain; and determining a frequency position of a second SSB corresponding to the second synchronization raster according to the position of the second synchronization raster. According to the method for determining the SSB, the terminal device, and the network device of the embodiments of the present application, the frequency range of the position of the SSB indicated can be increased, and meanwhile, the complexity of detecting the SSB by the terminal device can be reduced.

### CROSS-REFERENCE TO RELATED APPLICATION

This application is a continuation of the International Application No. PCT/CN2018/117308, filed on Nov. 23, 2018, the content of which is incorporated herein by reference in its entirety.

### TECHNICAL FIELD

The present application relates to the technical field of communication and, in particular, to a method for determining a synchronization signal block, a terminal device and a network device.

### BACKGROUND

At present, a position of a synchronization raster corresponding to a synchronization signal block (SSB) defined is mainly designed according to needs in terms of licensed spectrum. An interval between synchronization rasters is 1.2 MHz or 1.44 MHz, corresponding to the frequency ranges of 0-3 GHz and 3-24.25 GHz respectively. The reason why the interval between synchronization rasters is small is that the licensed frequency band supports different channel bandwidths and frequency band allocations, and it is necessary to allow synchronization signal blocks to be transmitted in as many locations as possible to deploy cells.

However, for unlicensed spectrum, its channel bandwidth is usually 20 MHz, which is shared among multiple operators, therefore, there is no need to define many positions for rasters in the channel bandwidth of 20 MHz, the reduction of the number of synchronization rasters defined with reference to the licensed spectrum can reduce the complexity of blind detection of a terminal device. However, in the case of reducing the number of synchronization rasters, the current method for indicating a synchronization raster is not applicable.

### SUMMARY

Embodiments of the present application provide a method for determining a synchronization signal block, a terminal device and a network device, which can increase a frequency range of a position of an SSB indicated and reduce the complexity of detecting the SSB by the terminal device.

In a first aspect, a method for determining a synchronization signal block is provided, and the method includes: receiving a first SSB, where the first SSB includes first position indication information, the first position indication information is used for determining a position of a second synchronization raster in a target synchronization raster set, and the target synchronization raster set includes part of synchronization rasters in a frequency domain; determining a frequency position of a second synchronization signal block corresponding to the second synchronization raster according to the position of the second synchronization raster.

In a second aspect, a method for determining a synchronization signal block is provided, and the method includes: transmitting a first synchronization signal block, where the first synchronization signal block includes first position indication information, the first position indication information is used for a terminal device to determine a position of a second synchronization raster corresponding to the second synchronization signal block in a target synchronization raster set, and the position of the second synchronization raster is used for the terminal device to determine a frequency position of the second synchronization signal block, and the target synchronization raster set includes part of synchronization rasters in a frequency domain.

In a third aspect, a terminal device is provided, and the terminal device is configured to execute the method in the first aspect or the implementations thereof. Specifically, the terminal device includes a functional module for executing the method in the above-mentioned first aspect or the implementations thereof.

In a fourth aspect, a network device is provided, and the network device is configured to execute the method in the second aspect or the implementations thereof. Specifically, the network device includes a functional module for executing the method in the above-mentioned second aspect or the implementations thereof.

In a fifth aspect, a terminal device is provided. The terminal device includes a processor and a memory. The memory is configured to store a computer program, and the processor is configured to call and run the computer program stored in the memory to execute the method in the above-mentioned first aspect or the implementations thereof.

In a sixth aspect, a network device is provided. The network device includes a processor and a memory. The memory is configured to store a computer program, and the processor is configured to call and run the computer program stored in the memory to execute the method in the above-mentioned second aspect or the implementations thereof.

In a seventh aspect, a chip is provided for implementing the method in any one of the above-mentioned first to second aspects or the implementations thereof. Specifically, the chip includes a processor for calling and running a computer program from a memory, which enables a device installed with the chip to execute the method in any one of the above-mentioned first to second aspects or the implementations thereof.

In an eighth aspect, a computer-readable storage medium is provided for storing a computer program that causes a computer to execute the method in any one of the above-mentioned first to second aspects or the implementations thereof.

In a ninth aspect, a computer program product is provided. The computer program product includes computer program instructions, the computer program instructions enable a computer to execute the method in any one of the above-mentioned first to second aspects or the implementations thereof.

In a tenth aspect, a computer program is provided, when the computer program is run on a computer, the computer is enabled to execute the method in any one of the above-mentioned first to second aspects described above or in the implementations thereof.

Through the technical scheme, when only part of synchronization rasters correspond to SSBs in a frequency range, the network device can indicate a position of a synchronization raster corresponding to another SSB or a position of a channel bandwidth where the synchronization raster is located through position indication information in one SSB, thereby increasing a frequency range of the position of the SSB indicated and reducing the complexity of detecting the SSB by the terminal device.

### BRIEF DESCRIPTION OF DRAWINGS

FIG. 1 is a schematic diagram of a communication system architecture provided by an embodiment of the present application.

FIG. 2 is a schematic diagram of an SSB provided by an embodiment of the present application.

FIG. 3 is a schematic diagram of a method for determining a synchronization signal block provided by an embodiment of the present application.

FIG. 4 is a schematic diagram of a method for determining a synchronization signal block provided by another embodiment of the present application.

FIG. 5 is a schematic block diagram of a terminal device according to an embodiment of the present application.

FIG. 6 is a schematic block diagram of a network device according to an embodiment of the present application.

FIG. 7 is a schematic block diagram of a communication device provided by an embodiment of the present application.

FIG. 8 is a schematic block diagram of a chip provided by an embodiment of the present application.

FIG. 9 is a schematic block diagram of a communication system provided by an embodiment of the present application.

### DESCRIPTION OF EMBODIMENTS

In the following, the technical scheme in the embodiments of the present application will be described with reference to the attached drawings. Obviously, the described embodiments are a part of the embodiments of the present application, but not all the embodiments. Based on the embodiments in the present application, all other embodiments obtained by ordinary technicians in this field without paying creative work belong to the scope of protection of the present application.

The technical scheme of the embodiments of the present application can be applied to various communication systems, such as a global system of mobile communication (GSM) system, a code division multiple access (CDMA) system, a wideband code division multiple access (WCDMA) system, a general packet radio service (GPRS), a long term evolution (LTE) system, an LTE frequency division duplex (FDD) system, an LTE time division duplex (TDD) system, a universal mobile telecommunications system (UMTS), a worldwide interoperability for microwave access (WiMAX) communication system or 5G system.

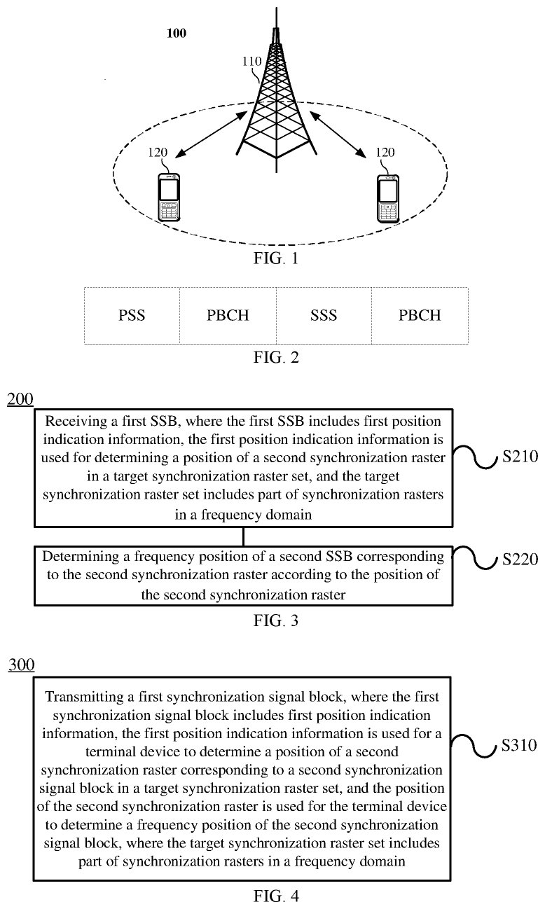

Illustratively, a communication system 100 to which the embodiment of the present application is applied is shown in FIG. 1. The communication system 100 may include a network device 110, which may be a device that communicates with a terminal device 120 (or referred to as a communication terminal, a terminal). The network device 110 can provide communication coverage for a specific geographical area, and can communicate with terminal devices located in the coverage area. In an embodiment, the network device 110 may be a base station (BTS) in a GSM system or a CDMA system, a base station (NodeB, NB) in a WCDMA system, or an evolutional Node B (eNB or eNodeB) in an LTE system, or a wireless controller in a cloud radio access network (CRAN), or the network device can be a mobile switching center, a relay station, an access point, a vehicle-mounted device, a wearable device, a hub, a switch, a bridge, a router, a network-side device in a 5G network, or a network device in a future evolved public land mobile network (PLMN).

The communication system 100 also includes at least one terminal device 120 located within the coverage of the network device 110. As the “terminal device” used herein, includes, but is not limited to, a connection via a wired line, such as a connection via a public switched telephone network (PSTN), a digital subscriber line (DSL), a digital cable and direct cable; and/or via another data connection/network; and/or via wireless interfaces, such as for cellular networks, wireless local area networks (WLAN), digital TV networks (e.g., DVB-H networks), satellite networks and AM-FM broadcast transmitter; and/or another apparatus of other terminal device that is set to receive/send communication signals; and/or internet of things (IoT) devices. A terminal device set to communicate through a wireless interface may be referred to as a “wireless communication terminal”, a “wireless terminal” or a “mobile terminal”. Examples of mobile terminals include, but are not limited to, satellite or cellular phones; personal communications system (PCS) terminals that can combine cellular radio phones with data processing, fax and data communication capabilities; which can include radio phones, pagers, Internet/intranet access, Web browser, memo pad, calendar, and/or PAD of a global positioning system (GPS) receiver; as well as conventional laptop and/or palmtop receivers or others electronic devices including radio telephone transceivers. The terminal device can refer to access terminals, user equipment (UE), user units, user stations, mobile stations, mobile platforms, remote stations, remote terminals, mobile equipment, user terminals, terminals, wireless communication equipment, user agents, or user apparatus. The access terminal can be cellular phones, cordless phones, session initiation protocol (SIP) phones, wireless local loop (WLL) stations, personal digital processing (PDA), handheld devices with wireless communication function, computing devices or other processing devices connected to wireless modems, vehicle-mounted devices, wearable devices, terminal devices in 5G networks, or terminal devices in the future evolution of PLMN and so forth.

In an embodiment, the terminal devices 120 can communicate with each other in a device to device (D2D) manner.

In an embodiment, the 5G system or the 5G network can also be called a new radio (NR) system or an NR network.

FIG. 1 exemplarily shows one network device and two terminal devices. In an embodiment, the communication system 100 may include a plurality of network devices and other numbers of terminal devices may be located within the coverage of each network device, which is not limited by the embodiments of the present application.

In an embodiment, the communication system 100 may also include other network entities such as a network controller and a mobility management entity, which is not limited by the embodiments of the present application.

It should be understood that devices with communication function in the network/system in the embodiments of the present application can be called communication devices. Taking the communication system 100 shown in FIG. 1 as an example, communication devices may include a network device 110 and a terminal device 120 with communication functions, which may be the specific devices described above, and will not be repeated here; the communication device may also include other devices in the communication system 100, such as a network controller, a mobility management entity and other network entities, which are not limited in the embodiments of the present application.

It should be understood that the terms “system” and “network” are often used interchangeably herein. The term “and/or” described herein is only a kind of relationship describing the related objects, which means that there can be three kinds of relationships, for example, A and/or B, which can mean that A exists alone, A and B exist at the same time, and B exists alone. In addition, the character “/” described herein generally indicates that the context objects are in an “or” relationship.

For common channels and signals (such as synchronization signals and broadcast channels) in an NR system, their coverage of the whole cell needs to be realized through multi-beam scanning, so as to make it convenient for a terminal device in the cell to receive such channels and signals. The multi-beam transmission of a synchronization signal (SS) is realized by defining the SS or a physical broadcast channel (PBCH) burst set. An SS burst set contains one or more SS/PBCH blocks. An SS/PBCH block is used to carry a synchronization signal and a broadcast channel of a beam. Therefore, an SS/PBCH burst set can contain synchronization signals of beams which are of the same number as the number of SS/PBCH blocks in a cell. Among them, the maximum number L of SS/PBCH blocks is related to the frequency band of the system, for example, when the frequency band of the system is 3 GHz, L=4; when the system frequency band is 3 GHz-6 GHz, L=8; when the system frequency band is 6 GHz-52.6 GHz, L=64.

FIG. 2 shows a schematic diagram of an SS/PBCH block (hereinafter referred to as SSB) according to an embodiment of the present application. As shown in FIG. 2, an SSB includes a primary synchronization signal (PSS) of a symbol, a secondary synchronization signal (SSS) of a symbol and NR-PBCHs of two symbols.

All SSBs in the SS/PBCH burst set are usually transmitted within a time window of 5 ms, and repeated at a certain period, where the period is configured by a high-level parameter SSB-timing, including 5 ms, 10 ms, 20 ms, 40 ms, 80 ms, 160 ms, etc.

When the terminal device needs to access the network, it needs to obtain system messages from the network side, some of which can be carried by an NR-PBCH and some of which can be carried by an NR physical downlink shared channel (PDSCH), where the system message carried by the NR-PDSCH includes remaining minimum system information (RMSI).

Downlink control information (DCI) corresponding to the NR-PDSCH is carried on an NR physical downlink control channel (PDCCH), the location of the time-frequency resource where the NR-PDCCH is located is indicated by control resource set (CORESET) information carried by the NR-PBCH, that is, the Type0-PDCCH common search space information.

Since not NR-PBCHs in every SSB include information for determining the RMSI, the NR-PBCH also carries information indicating whether the SSB in which it is located is associated with RMSI, or information indicating whether it is associated with a Type0-PDCCH common search space, such information can be called RMSI presence flag information.

In an embodiment, the RMSI presence flag information can be indicated by a reserved value in an information field of physical resource block (PRB) grid offset in the NR-PBCH, that is, it is indicated that the current SSB is not associated with RMSI or Type0-PDCCH common search space through the information field of PRB grid offset. Specifically, the information field of PRB grid offset is used to indicate an offset between PRB grids between an SSB and a non-SSB channel or signal, the information field of PRB grid offset may include 4 or 5 bits, and the corresponding offset generally includes 0-11 or 0-23 subcarriers. Therefore, the information field of PRB grid offset also includes 4 or 8 reserved values, which can be used for indicating that the current SSB is not associated with RMSI or Type0-PDCCH common search space.

For example, suppose that the information field of PRB grid offset can include 4 bits, which can represent 16 values from 0-15; and the offset between the PRB grids between SSB and a non-SSB channel or signal includes 0-11 subcarriers, that is, 12 values, then 12-15 that can be represented by the information field of PRB grid offset are the reserved values. If the information field of PRB grid offset takes any value between 0-11, it corresponds to the number of offset subcarriers between the PRB grids between the SSB and the non-SSB channel or signal, and can also indicate that the SSB in which it is located is associated with RMSI or Type0-PDCCH common search space; if the information field of PRB grid offset takes any value from 12-15, it means that the SSB in which it is located is not associated with RMSI or Type0-PDCCH common search space.

In addition, the NR-PBCH also includes an information field of RMSI-PDCCH-Config, or referred to as an information field of RMSI-PDCCH-ConfigSIB1, which is usually indicated by 8 bits, and is used to indicate a location of RMSI associated with an SSB in which it is located. However, when the information field of PRB grid offset indicates that the current SSB is not associated with RMSI or Type0-PDCCH common search space, the information field of RMSI-PDCCH-Config can also be used to indicate frequency location information of another SSB, thus making it possible for reducing blind detection by the terminal device, which can detect, according to the frequency location information of the another SSB, a PBCH in the another SSB to obtain RMSI-PDCCH-Config information and receive RMSI.

For the wireless frequency in NR, a frequency position of an SSB is usually defined by a synchronization raster, as shown in Table 1 below, possible frequency positions of synchronization rasters corresponding to the SSB in different frequency ranges can be determined by the formula in Table 1 and indexed by SS_{REF}.

TABLE 1
SS rasters for different frequency ranges

| | | Frequency positions of synchronization |
|---|---|---|
| Frequency range | | rasters of SSB SS_{REF} |
| 0-3000 | MHz | N * 1200 kHz + M * 50 kHz, |
| | | N = 1:2499, M ϵ {1, 3, 5} (Note 1) |
| 3000-24250 | MHz | 3000 MHz + N * 1.44 MHz |
| | | N = 0:14756 |

NOTE 1:
The default value for operating bands with SCS spaced channel raster is M = 3.

After determining the synchronization raster, the resource mapping of the SSB can be determined according to Table 2 below. That is, the synchronization raster is usually located in the PRB indexed 10 among the 20 PRBs included in the SSB, and is usually a resource element (RE) indexed 0 in the PRB.

TABLE 2
Synchronization raster to SSB resource mapping

| Resource element index k | 0 |
|---|---|
| Physical resource block number | nPRB = 10 |
| nPRB of the SSB | |

For synchronization rasters, the distribution of synchronization rasters in different bands can be determined by the following Table 3. For example, for band n77, the index range of synchronization rasters is 7711-8329, with a total of 619 synchronization rasters, where the index of synchronization rasters is a global synchronization channel number (GSCN).

TABLE 3
Applicable SS raster entries per operating band

| NR Operating | Subcarrier spacing | Range of GSCN |
|---|---|---|
| Band | of SSB | (First-<Stepsize>-Last) |
| n1 | 15 kHz | 5279-<1>-5419 |
| n2 | 15 kHz | 4829-<1>-4969 |
| n3 | 15 kHz | 4517-<1>-4693 |
| n5 | 15 kHz | 2177-<1>-2230 |
| | 30 kHz | 2183-<1>-2224 |
| n7 | 15 kHz | 6554-<1>-6718 |
| n8 | 15 kHz | 2318-<1>-2395 |
| n12 | 15 kHz | 1828-<1>-1858 |
| n20 | 15 kHz | 1982-<1>-2047 |
| n25 | 15 kHz | 4829-<1>-4981 |
| n28 | 15 kHz | 1901-<1>-2002 |
| n34 | 15 kHz | 5030-<1>-5056 |
| n38 | 15 kHz | 6431-<1>-6544 |
| n39 | 15 kHz | 4706-<1>-4795 |
| n40 | 15 kHz | 5756-<1>-5995 |
| n41 | 15 kHz | 6246-<3>-6714 |
| | 30 kHz | 6252-<3>-6714 |
| n51 | 15 kHz | 3572-<1>-3574 |
| n66 | 15 kHz | 5279-<1>-5494 |
| | 30 kHz | 5285-<1>-5488 |
| n70 | 15 kHz | 4993-<1>-5044 |
| n71 | 15 kHz | 1547-<1>-1624 |
| n75 | 15 kHz | 3584-<1>-3787 |
| n76 | 15 kHz | 3572-<1>-3574 |
| n77 | 30 kHz | 7711-<1>-8329 |
| n78 | 30 kHz | 7711-<1>-8051 |
| n79 | 30 kHz | 8480-<16>-8880 |

To sum up, when the reserved value in the information field of PRB grid offset (represented by k_{SSB}) indicates that the current SSB is not associated with RMSI or Type0-PDCCH common search space, the value of k_{SSB} and the bits in the information field of pdcch-ConfigSIB1 can indicate frequency position information of another SSB, here the another SSB is referred to as target SSB compared to the current SSB, and the raster corresponding to the target SSB is referred to as target synchronization raster.

The offset of the target synchronization raster relative to the current synchronization raster corresponding to the current SSB is indicated by the information field of pdcch-ConfigSIB1, when the information field of pdcch-ConfigSIB1 contains 8 bits, positions of 256 possible target synchronization rasters can be indicated. Combined with N different reserved values in the information field of PRB grid offset, positions of N*265 synchronization rasters can be indicated, as shown in Table 4 and Table 5 below.

Specifically, Table 4 and Table 5 respectively show indication conditions in different frequency ranges (FR), Table 4 corresponds to FR1, that is, the information field of PRB grid offset includes 5 bits, which can represent 32 values from 0-31; an offset between PRB grids between an SSB and a non-SSB channel or signal includes 0-23 subcarriers, and when the reserved value of k_{SSB} is 24-31, an SSB where the corresponding identifier is located is not associated with RMSI or Type0-PDCCH common search space. Table 5 corresponds to FR2, that is, the information field of PRB grid offset includes 4 bits, which can represent 16 values from 0-15; an offset between PRB grids between an SSB and a non-SSB channel or signal includes 0-11 subcarriers, and when the reserved value of k_{SSB} is 12-15, an SSB where the corresponding identifier is located is not associated with RMSI or Type0-PDCCH common search space.

It should be understood that, as shown in Table 4 and Table 5, the offset N_{GSCN}^{Offset} of the GSCN of the target synchronization raster corresponding to the target SSB relative to the GSCN of the current synchronization raster corresponding to the current SSB is jointly indicated by k_{SSB} and the pdcch-ConfigSIB1, and then the GSCN of the synchronization raster where the target SSB is located is obtained by Formula N_{GSCN}^{Reference}+N_{GSCN}^{Offset}, where N_{GSCN}^{Reference} represents the GSCN of the current synchronization raster corresponding to the current SSB.

TABLE 4
Mapping between the combination of k_{SSB} and
pdcch-ConfigSIB1 to N_{GSCN}^{Offset} for FR1

| k_{SSB} | pdcch-ConfigSIB1 | N_{GSCN}^{Offset} |
|---|---|---|
| 24 | 0, 1, . . . , 255 | 1, 2, . . . , 256 |
| 25 | 0, 1, . . . , 255 | 257, 258, . . . , 512 |
| 26 | 0, 1, . . . , 255 | 513, 514, . . . , 768 |
| 27 | 0, 1, . . . , 255 | −1, −2, . . . , −256 |
| 28 | 0, 1, . . . , 255 | −257, −258, . . . , −512 |
| 29 | 0, 1, . . . , 255 | −513, −514, . . . , −768 |
| 30 | 0, 1, . . . , 255 | Reserved value (Reserved, |
| | | Reserved, . . . , Reserved) |

TABLE 5
Mapping between the combination of k_{SSB} and
pdcch-ConfigSIB1 to N_{GSCN}^{Offset} for FR2

| k_{SSB} | pdcch-ConfigSIB1 | N_{GSCN}^{Offset} |
|---|---|---|
| 12 | 0, 1, . . . , 255 | 1, 2, . . . , 256 |
| 13 | 0, 1, . . . , 255 | −1, −2, . . . , −256 |
| 14 | 0, 1, . . . , 255 | Reserved value (Reserved, |
| | | Reserved, . . . , Reserved) |

Among them, the range indicated in Table 4 includes −768 . . . −1, 1 . . . 768, and the range indicated in Table 5 includes −256 . . . −1, 1 . . . 256. Meanwhile, when the terminal device receives k_{SSB}=31 in FR1 corresponding to Table 4 or k_{SSB}=15 corresponding to FR2, the terminal device considers that there is no target SSB within the range [N_{GSCN}^{Reference}−N_{GSCN}^{Start}, N_{GSCN}^{Reference}+N_{GSCN}^{End}] of GSCN, and the target SSB is the SS/PBCH block associated with RMSI or Type0-PDCCH common search space, where N_{GSCN}^{Start} and N_{GSCN}^{End} are determined according to the upper 4 bits and the lower 4 bits of RMSI-PDCCH-Config respectively.

The synchronization raster defined above is mainly designed according to the needs of licensed spectrum. The interval between synchronization rasters is 1.2 MHz or 1.44 MHz, corresponding to the frequency ranges of 0-3 GHz and 3-24.25 GHz respectively. The reason why the interval between synchronization rasters is small is that the licensed frequency band supports different channel bandwidths and frequency band allocations, and it is necessary to allow SSB to be transmitted in as many locations as possible to deploy cells, but this is not applicable to unlicensed spectrum.

Unlicensed spectrum is a spectrum that can be used for radio device communication by countries and regions, this spectrum is usually regarded as a shared spectrum, that is, communication devices in different communication systems can use this spectrum as long as they meet the regulatory requirements set by countries or regions on this spectrum, without applying for exclusive spectrum license from the government. In order to make the communication systems that use the unlicensed spectrum for wireless communication coexist amicably on this spectrum, some countries or regions have stipulated the legal requirements that must be met when using the unlicensed spectrum. For example, in Europe, a communication device follows the principle of “listen-before-talk” (LBT), that is, the communication device needs to listen to the channel before transmitting signals on the channel of the unlicensed spectrum, and only when the result of channel listening is that the channel is idle can the communication device transmit signals; if the result of channel listening performed by the communication device on the channel of the unlicensed spectrum is that the channel is busy, the communication device cannot transmit signals. Moreover, in order to ensure fairness, in one transmission, the duration of using the channel of the unlicensed spectrum by the communication device for signal transmission cannot exceed the maximum channel occupation time (MCOT).

For the unlicensed spectrum, the channel bandwidth is usually 20 MHz, which is shared among multiple operators, so there is no need to define many positions of rasters in the channel bandwidth of 20 MHz, the reduction of the number of synchronization rasters defined with reference to the licensed spectrum can reduce the complexity of blind detection of a terminal device. In the case of reducing the number of synchronization rasters, it is necessary to propose a new method for indicating a synchronization raster, that is, a new method for indicating an SSB, therefore, the embodiments of the present application propose a method for determining an SSB, which can use the unlicensed spectrum.

FIG. 3 is a schematic flowchart of a method 200 for determining a synchronization signal block provided by an embodiment of the present application. The method 200 can be executed by a terminal device, for example, the terminal device can be the terminal device shown in FIG. 1. As shown in FIG. 3, the method 200 includes the following steps: S210, receiving a first SSB, where the first SSB includes first position indication information, the first position indication information is used for determining a position of a second synchronization raster in a target synchronization raster set, and the target synchronization raster set includes part of synchronization rasters in a frequency domain; S220: determining a frequency position of a second SSB corresponding to the second synchronization raster according to the position of the second synchronization raster.

It should be understood that the frequency domain in the embodiment of the present application can refer to any frequency range, for example, the frequency domain can be a licensed frequency domain or an unlicensed frequency domain. There are several synchronization rasters in the frequency domain, and, and the synchronization rasters in the target synchronization raster set correspond to SSB(s), for example, the target synchronization raster set includes a first synchronization raster and a second synchronization raster, where the first synchronization raster corresponds to a first SSB and the second synchronization raster corresponds to a second SSB. In an embodiment, synchronization rasters that do not belong to the target synchronization raster set in the frequency domain may not have corresponding SSBs. For the convenience of explanation, in the present application, an example is taken where the frequency domain refers to the unlicensed frequency range for illustration.

When the NR system is deployed independently on the unlicensed spectrum, there will also be cases where some SSBs are not associated with RMSI. At this time, the position of another SSB can also be indicated by the information field of PRB grid offset (represented by k_{SSB}) and the field of pdcch-ConfigSIB1 included in the PBCH in the SSB, the another SSB can be an SSB associated with RMSI or indicate a further SSB which is associated with RMSJ. In addition, in the unlicensed spectrum, the synchronization raster is redefined, that is, the positions of the defined synchronization rasters are reduced, that is, only part of synchronization rasters correspond to SSBs, the part of synchronization rasters belong to the target synchronization raster set. Therefore, a new indication method is used for indicating an SSB of an NR system on an unlicensed spectrum.

In an embodiment, the distribution of synchronization rasters belonging to the target synchronization raster set and synchronization rasters not belonging to the target synchronization raster set in the frequency domain can be set according to the actual application, for the convenience of explanation, the synchronization rasters belonging to the target synchronization raster set are called valid synchronization rasters, which correspond to SSBs, while the synchronization rasters not belonging to the target synchronization raster set can be called invalid synchronization rasters, which do not correspond to SSBs. In this frequency range, the valid synchronization rasters and the invalid synchronization rasters can be randomly distributed, for example, the valid synchronization rasters and the invalid synchronization rasters can be randomly distributed, or they can also be distributed according to certain rules, and the embodiment of the present application is not limited thereto.

For example, valid synchronization rasters can be evenly distributed in the frequency range, that is, the number of invalid synchronization rasters included between any two adjacent synchronization rasters is a fixed value, which can be an arbitrary preset value, for example, when the preset value is equal to 1, it means that one of any two adjacent synchronization rasters is a valid synchronization raster and the other is an invalid synchronization raster. Specifically, it is assumed that the indexes of all synchronization rasters in this frequency domain adopt the above-mentioned GSCNs as shown in Table 1 and Table 3, that is, all synchronization rasters are jointly indexed, when the preset value is equal to 1, the GSCNs representing the valid synchronization rasters are even and the GSCNs representing the invalid synchronization rasters are odd, or the GSCNs representing the valid synchronization rasters are odd and the GSCNs representing the invalid synchronization rasters are even.

In an embodiment, each synchronization raster in the target synchronization raster set corresponds to an SSB, and the position of the corresponding SSB can be determined according to the position of each synchronization raster, for example, the frequency position of the first SSB can be determined according to the position of the first synchronization raster, and similarly, the frequency position of the second SSB can be determined according to the position of the second synchronization raster. Specifically, the positions of SSBs corresponding to synchronization rasters are determined similarly to Table 4 above, for example, the first synchronization raster can be the center frequency of the first SSB and the second synchronization raster can be the center frequency of the second SSB.

In S210, the terminal device receives the first SSB transmitted by the network device, the first SSB corresponds to the first synchronization raster in the target synchronization raster set, and the first SSB includes the first position indication information, and the first position indication information can be used for the terminal device to determine the position of the second synchronization raster in the target synchronization raster set, and then in S220, the terminal device determines the frequency position of the corresponding second SSB according to the position of the second synchronization raster, and receives the second SSB.

In an embodiment, the first SSB may further include first association information, which is used for indicating that the first SSB is not associated with RMSI. Specifically, the first association information can be the above-mentioned information field of PRB grid offset in the NR-PBCH, that is, whether the current SSB is associated with RMSI or Type0-PDCCH common search space is indicated through the information field of PRB grid offset, for example, when the reserved value can be obtained through the information field of PRB grid offset, it means that the current first SSB is not associated with RMSI or Type0-PDCCH common search space, for brevity, reference can be made to Table 4 and Table 5 and related descriptions above for the specific values, which will not be repeated here.

The first position indication information included in the first SSB can be used to determine the position of the second synchronization raster, and the second SSB corresponding to the second synchronization raster may or may not be associated with RMSI, if the second SSB is not associated with RMSI, another SSB can be determined according to second position indication information included in the second SSB; if the second SSB is associated with RMSI, related information of the associated RMSI can be determined according to the SSB, and when the second SSB is associated with RMSI, reference can be made to the SSB associated with RMSI in the licensed spectrum, which is not repeated here for brevity.

For example, suppose that the second SSB is associated with RMSI, and the second SSB may include second association information indicating that the second SSB is associated with RMSI, where the second association information may be the above-mentioned information field of PRB grid offset in the NR-PBCH, and the value of the information field of PRB grid offset indicates the offset between PRB grids between an SSB and a non-SSB channel or signal, and may also indicate that the second SSB is associated with RMSI. The second SSB also includes second location indication information, if the second SSB is associated with RMSI, the second location indication information can be used to determine the location of an RMSI CORESET, that is, to determine the location of a time-frequency resource where the NR-PDCCH is located, the NR-PDCCH carries DCI corresponding to the NR-PDCCH and the NR-PDCCH is used to carry RSMI, so that the location of RMSI can be determined.

Since the target synchronization raster set only includes part of synchronization rasters in a frequency domain, if the synchronization rasters in the frequency domain still adopt the indexing method as shown in Table 3 above, there will be a large number of invalid locations in the mapping tables of k_{SSB} and pdcch-ConfigSIB1, and N_{GSCN}^{Offset} in Table 4 and Table 5 as shown above, so it is necessary to determine the position of the second synchronization raster in different ways according to the first position indication information in the embodiment of the present application. In the following, detailed description will be made with reference to several specific embodiments.

In a first embodiment, similar to GSCN mentioned above, the synchronization rasters in the target synchronization raster set are indexed, the positions of respective synchronization rasters in the target synchronization raster set and the indexes are in a one-to-one correspondence, and the first position indication information indicates a first offset, the first offset is the difference between the index of the second synchronization raster and the index of the first synchronization raster, then the terminal device can determine a sum of the index corresponding to the position of the first synchronization raster and the first offset as the index of the second synchronization raster, and determine the position of the second synchronization raster according to the index of the second synchronization raster.

Specifically, the synchronization rasters in the target synchronization raster set can be individually indexed, or all synchronization rasters in the frequency domain can be jointly indexed. If the synchronization rasters in the target synchronization raster set are indexed separately, that is, the synchronization rasters in the target synchronization raster set are indexed separately instead of using GSCNs as shown in Table 3, then the mapping relationships shown in Table 4 and Table 5 can still be used to determine the first offset N₁^{Offset}=N_{GSCN}^{Offset}, and the sum of the index N^{Reference} of the first synchronization raster and the first offset N^{Offset} is the index of the second synchronization raster, and the corresponding frequency domain position can be determined according to the index of the second synchronization raster.

For example, suppose that synchronization rasters with even original GSCNs in the frequency domain belong to the target synchronization raster set, and synchronization rasters with odd original GSCNs do not belong to the target synchronization raster set, and the synchronization rasters in the target synchronization raster set are re-indexed, the GSCNs of the synchronization rasters in the target synchronization raster set can be divided by 2 to obtain the new indexes, and then the first offset N₁^{Offset}=N_{GSCN}^{Offset} can be determined according to the mapping relationships shown in Table 4 and Table 5, and the sum of the index N^{Reference} of the first synchronization raster and the first offset N^{Offset} is the index of the second synchronization raster.

If all synchronization rasters in the frequency domain are jointly indexed, for example, the indexes still adopt GSCNs as shown in Table 3, only some synchronization rasters in these synchronization rasters belong to the target synchronization raster set, and some values in Tables 4 and 5 are invalid, therefore, the values of N_{GSCN}^{Offset} in Table 4 and Table 5 can be adjusted to define a new mapping table and possible N_{GSCN}^{Offset}, that is, the first offset N_{GSCN}^{Offset}, which can be used to indicate the offset between positions of synchronization rasters in the target synchronization raster set.

For example, it is still assumed that the synchronization rasters with even GSCNs in the frequency belong to the target synchronization raster set, and the synchronization rasters with odd GSCNs do not belong to the target synchronization raster set, keep the GSCH unchanged and multiply all the N_{GSCN}^{Offset} in Table 4 and Table 5 by 2, which can be used as new mapping relationships to determine the position of the second synchronization raster.

In a second embodiment, the first position indication information may also indicate a second offset, and the second offset indicates the number of synchronization rasters belonging to the target synchronization raster set between the position of the second synchronization raster and the position of the first synchronization raster, and an offset direction of the position of the second synchronization raster relative to the position of the first synchronization raster. Then the method 200 further includes: the terminal device determining the position of the second synchronization raster according to the position of the first synchronization raster and the second offset. For the second offset, the mapping relationships shown in Table 4 and Table 5 can still be used to determine the second offset N₂^{Offset}=N_{GSCN}^{Offset}, the absolute value of the second offset is the number of synchronization rasters belonging to the target synchronization raster set between the position of the second synchronization raster and the position of the first synchronization raster, and the sign of the second offset indicates the offset direction of the position of the second synchronization raster relative to the position of the first synchronization raster.

Specifically, the synchronization rasters in the target synchronization raster set can be indexed separately, that is, instead of using GSCNs as shown in Table 3 above, the synchronization rasters in the target synchronization raster set are indexed separately, and the indexes and positions of respective synchronization rasters are in a one-to-one correspondence, at this time, the process of obtaining the position of the second synchronization raster through the second offset is consistent with the process of obtaining the position of the second synchronization raster through the first offset in the first embodiment described above, that is, the mapping relationships shown in Table 4 and Table 5 can still be used to determine the second offset N₂^{Offset}=N_{GSCN}^{Offset}, and then the sum of the index of the first synchronization raster N^{Reference} and the second offset N₂^{Offset} can be used as the index of the second synchronization raster, and the corresponding frequency position can be determined according to the index of the second synchronization raster.

Alternatively, all synchronization rasters in the frequency domain can also be jointly indexed, for example, the indexes are still GSCNs as shown in Table 3, only part of synchronization rasters in these synchronization rasters belong to the target synchronization raster set, at this time, the terminal device may not be able to accurately determine the position of the second synchronization raster only based on the second offset, therefore, the method 200 further includes: the terminal device determining, according to the second offset, the number of synchronization rasters between the position of the first synchronization raster and the position of the second synchronization raster and not belonging to the target synchronization raster set as a first value, according to the distribution of synchronization rasters in the target synchronization raster set in all synchronization rasters in the frequency, where the first value is an integer. Suppose that the sum of the absolute values of the first value and the second offset is equal to a second value, the second value is also an integer. The sign of the second offset indicates the offset direction of the position of the second synchronization raster relative to the position of the first synchronization raster, if the second offset is positive, the terminal device can determine the index of the second synchronization raster according to the sum of the index corresponding to the position of the first synchronization raster and the positive second value; if the second offset is negative, take negative of the original second value, and determine the sum of the index corresponding to the position of the first synchronization raster and the negative second value as the index of the second synchronization raster, so as to determine the position corresponding to the index of the second synchronization raster.

Specifically, the distribution of the synchronization rasters in the target synchronization raster set in all synchronization rasters in the frequency domain is the distribution of the valid synchronization rasters and the invalid synchronization rasters in the frequency domain, which is not repeated here for brevity.

According to the first value obtained through calculation of the distribution of the target synchronization raster set, the terminal device can determine the frequency position of the second synchronization raster according to the sum of the first value and the absolute value of the second offset in the first position indication information.

In a third embodiment, the frequency domain may include multiple channel bandwidths, a frequency position of a first channel bandwidth where the first synchronization raster is located is different from a frequency position of a second channel bandwidth where the second synchronization raster is located, and the first position indication information indicates a third offset, and the third offset is used to determine an offset between the frequency position of the first channel bandwidth and the frequency position of the second channel bandwidth, and the third offset can be positive or negative; then the method 200 further includes: the terminal device determining the frequency position of the second channel bandwidth according to the frequency position of the first channel bandwidth and the third offset, the second channel bandwidth including the position of the second synchronization raster, and the terminal device determining the position of the second synchronization raster in the second channel bandwidth through blind detection, so as to determine the frequency position of the second SSB corresponding to the second synchronization raster.

Specifically, multiple channel bandwidths included in the frequency domain can be equal, then the absolute value of the third offset can represent a multiple of the equal channel bandwidth, that is, the number of channel bandwidths between the first channel bandwidth and the second channel bandwidth, and the sign of the third offset represents the offset direction of the first channel bandwidth relative to the second channel bandwidth. Therefore, for this third offset, the mapping relationships shown in Table 4 and Table 5 can still be used to determine the third offset N₃^{Offset}=N_{GSCN}^{Offset}, and the frequency position of the second channel bandwidth can be determined by multiplying the third offset N₃^{Offset} by the size of each channel bandwidth.

For example, the channel bandwidth here can refer to the unit bandwidth for channel listening and channel access on the unlicensed spectrum, and each channel bandwidth is equal to 20 MHz. Because the channel occupation of the unlicensed spectrum takes 20 MHz as the unit, if the NR system is deployed independently on the unlicensed spectrum, the SSB needs to be transmitted on the channel bandwidth of 20 MHz. Referring to the calculation method for a licensed spectrum, in the 5-7 GHz frequency band where the unlicensed spectrum is located, the interval between synchronization rasters is calculated according to 1.44 MHz, so there can be at most 14 synchronization rasters in the 20 MHz range. By reducing the number of synchronization rasters in the unlicensed spectrum, there may be only a very limited number of valid synchronization rasters in 20 MHz, that is, the number of synchronization rasters in the target synchronization raster set is very limited, for example, there may be only 1-5 synchronization rasters.

Because the distribution range of unlicensed spectrum is relatively wide, when it is necessary to instruct the terminal device to search for the second SSB in the spectrum with a relatively long interval, the above-mentioned third offset N₃^{Offset} can be used for indication, the third offset N₃^{Offset} can be obtained through the above-mentioned Table 4 and Table 5, the difference between the first channel bandwidth and the second channel bandwidth is equal to the product of the third offset and 20 MHz, so the position of the second channel bandwidth can be obtained according to the product and the position of the first channel bandwidth.

Accordingly, the terminal device searches for the second SSB on the determined second channel bandwidth. Because the number of synchronization rasters in the bandwidth of 20 MHz is limited, the way in which the terminal device performs blind detection on the second channel bandwidth and obtains the second SSB will not increase the complexity greatly compared with the first and second embodiments mentioned above.

It should be understood that, similar to the above three embodiments, the terminal device can determine the position of the second synchronization raster according to different offsets included in the first position indication information by adopting corresponding methods, and then determine the frequency position of the second SSB corresponding to the second synchronization raster, and receive the second SSB at the frequency position.

Therefore, in the method for determining a synchronization signal block in the embodiment of the present application, when only part of synchronization rasters correspond to SSBs in the frequency domain, the network device can indicate the position of the synchronization raster corresponding to another SSB or the position of the channel bandwidth where the synchronization raster is located through the position indication information in one SSB, thereby increasing the frequency range of the position of the SSB indicated and reducing the complexity of detecting the SSB by the terminal device.

The method for determining a synchronization signal block according to the embodiments of the present application is described in detail from the perspective of the terminal device in the above description with reference to FIG. 1 to FIG. 3, and the method for determining a synchronization signal block according to the embodiment of the present application will be described from the perspective of the network device with reference to FIG. 4.

FIG. 4 shows a schematic flowchart of a method 300 for determining a synchronization signal block according to an embodiment of the present application, which can be executed by a network device, such as the network device shown in FIG. 1. As shown in FIG. 4, the method 300 includes: S310, transmitting a first synchronization signal block, where the first synchronization signal block includes first position indication information, the first position indication information is used for a terminal device to determine a position of a second synchronization raster corresponding to a second synchronization signal block in a target synchronization raster set, and the position of the second synchronization raster is used for the terminal device to determine a frequency position of the second synchronization signal block, where the target synchronization raster set includes part of synchronization rasters in a frequency domain.

In an embodiment, the frequency domain is an unlicensed frequency domain.

In an embodiment, positions of synchronization rasters in the target synchronization raster set and indexes are in a one-to-one correspondence, the first position indication information indicates a first offset, the first offset is a difference between an index of the second synchronization raster and an index of a first synchronization raster, and the first synchronization raster corresponds to the first synchronization signal block.

In an embodiment, the first position indication information indicates a second offset, the second offset indicates the number of synchronization rasters belonging to the target synchronization raster set between the position of the second synchronization raster and a position of a first synchronization raster, and an offset direction of the position of the second synchronization raster relative to the position of the first synchronization raster, and the first synchronization raster corresponds to the first synchronization signal block.

In an embodiment, the frequency includes multiple channel bandwidths, a frequency position of a first channel bandwidth where a first synchronization raster is located is different from a frequency position of a second channel bandwidth where the second synchronization raster is located, and the first synchronization raster corresponds to the first synchronization signal block, and the first position indication information indicates a third offset, the third offset is the offset between the first channel and the second channel.

In an embodiment, the multiple channel bandwidths are equal.

In an embodiment, the third offset indicates the number of channel bandwidths between the frequency position of the first channel bandwidth and the frequency position of the second channel bandwidth, and an offset direction of the frequency position of the first channel bandwidth relative to the frequency position of the second channel bandwidth.

In an embodiment, the target synchronization raster set includes a first synchronization raster corresponding to the first synchronization signal block.

In an embodiment, the first synchronization signal block further includes first association information, and the first association information is used for indicating that the first synchronization signal block is not associated with remaining minimum system information RMSI.

In an embodiment, a position of the first synchronization raster is a central frequency of the first synchronization signal block, and a position of the second synchronization raster is a central frequency of the second synchronization signal block.

It should be understood that the method 300 can correspond to the above-mentioned method 200, where the network device in the method 300 can correspond to the network device in the method 200, and the terminal device in the method 300 can correspond to the terminal device in the method 200, which is not repeated here for brevity.

Therefore, in the method for determining a synchronization signal block in the embodiment of the present application, when only some valid synchronization rasters in the frequency range correspond to SSBs, the network device can indicate the position of the synchronization raster corresponding to another SSB or the position of the channel bandwidth where the synchronization raster is located according to position indication information in one SSB, thereby increasing the frequency range of the position of the SSB indicated and reducing the complexity of detecting the SSB by the terminal device.

It should be understood that in various embodiments of the present application, the sizes of the serial numbers in the above-mentioned processes do not mean the order of execution, and the order of execution of each process should be determined according to its function and internal logic, and should not constitute any limitation on the implementation process of the embodiment of the present application.

In addition, the term “and/or” described herein is only a description of the relationship between related objects, which means that there can be three kinds of relationships, for example, A and/or B, which can mean that A exists alone, A and B exist at the same time, and B exists alone. In addition, the character “/” described herein generally indicates that the context objects are in an “or” relationship.

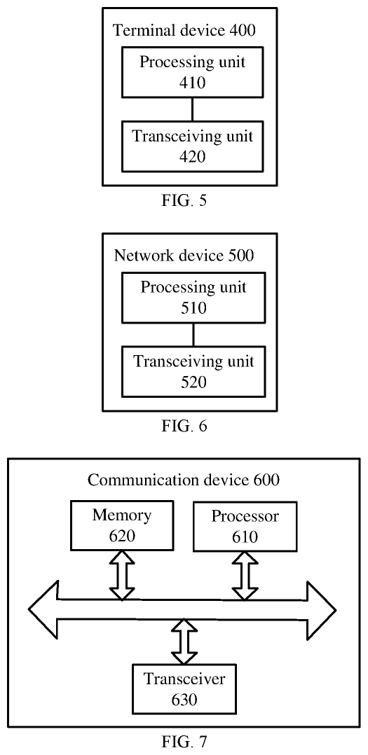

The method for determining a synchronization signal block according to the embodiment of the present application is described in detail above with reference to FIG. 1 to FIG. 4, and the terminal device and network device according to the embodiment of the present application will be described below with reference to FIG. 5 to FIG. 9.

As shown in FIG. 5, a terminal device 400 according to an embodiment of the present application includes: a processing unit 410 and a transceiving unit 420. Specifically, the transceiving unit 420 is configured to: receive a first synchronization signal block, where the first synchronization signal block includes first position indication information, the first position indication information is used for determining a position of a second synchronization raster in a target synchronization raster set, and the target synchronization raster set includes part of synchronization rasters in a frequency domain; the processing unit 410 is configured to: determine a frequency position of a second synchronization signal block corresponding to the second synchronization raster according to the position of the second synchronization raster.

In an embodiment, the frequency domain is an unlicensed frequency domain.

In an embodiment, positions of synchronization rasters in the target synchronization raster set and indexes are in a one-to-one correspondence, the first position indication information indicates a first offset, and the first offset is a difference between an index of the second synchronization raster and an index of a first synchronization raster, and the first synchronization raster corresponds to the first synchronization signal block; the processing unit 410 is further configured to: determine a sum of an index corresponding to a position of the first synchronization raster and the first offset as the index of the second synchronization raster; determine the position of the second synchronization raster according to the index of the second synchronization raster.

In an embodiment, the first position indication information indicates a second offset, the second offset indicates the number of synchronization rasters belonging to the target synchronization raster set between the position of the second synchronization raster and a position of a first synchronization raster, and an offset direction of the position of the second synchronization raster relative to the position of the first synchronization raster, and the first synchronization raster corresponds to the first synchronization signal block; the processing unit 410 is further configured to: determine the position of the second synchronization raster according to the position of the first synchronization raster and the second offset.

In an embodiment, the processing unit 410 is further configured to: determine, according to the second offset, the number of synchronization rasters between the position of the first synchronization raster and the position of the second synchronization raster and not belonging to the target synchronization raster set as a first value, according to a distribution of synchronization rasters in the target synchronization raster set in all synchronization rasters in the frequency domain; determine the position of the second synchronization raster according to the position of the first synchronization raster, the first value and the second offset.

In an embodiment, the distribution includes: the number of synchronization rasters between any two adjacent synchronization rasters in the target synchronization raster set and not belonging to the target synchronization raster set being a preset value.

In an embodiment, the distribution includes: an index of a synchronization raster in the target synchronization raster set being even, and an index of a synchronization raster outside the target synchronization raster set being odd; or an index of a synchronization raster in the target synchronization raster set being odd, and an index of a synchronization raster outside the target synchronization raster set being even.

In an embodiment, the frequency domain includes multiple channel bandwidths, a frequency position of a first channel bandwidth where a first synchronization raster is located is different from a frequency position of a second channel bandwidth where the second synchronization raster is located, and the first synchronization raster corresponds to the first synchronization signal block, where the first position indication information indicates a third offset, and the third offset is an offset between the frequency position of the first channel bandwidth and the frequency position of the second channel bandwidth; the processing unit 410 is further configured to: determine the frequency position of the second channel bandwidth according to the frequency position of the first channel bandwidth and the third offset.

In an embodiment, the processing unit 410 is further configured to: determine the position of the second synchronization raster in the second channel bandwidth through blind detection.

In an embodiment, the multiple channel bandwidths are equal.

In an embodiment, the third offset indicates a number of channel bandwidths between the frequency position of the first channel bandwidth and the frequency position of the second channel bandwidth, and an offset direction of the frequency position of the first channel bandwidth relative to the frequency position of the second channel bandwidth.

In an embodiment, the target synchronization raster set includes a first synchronization raster corresponding to the first synchronization signal block.

In an embodiment, the first synchronization signal block further includes first association information, and the first association information is used for indicating that the first synchronization signal block is not associated with remaining minimum system information RMSI.

In an embodiment, a position of the first synchronization raster is a central frequency of the first synchronization signal block, and a position of the second synchronization raster is a central frequency of the second synchronization signal block.

It should be understood that the terminal device 400 according to the embodiment of the present application can correspond to the execution of the method 200 in the embodiment of the present application, and the above and other operations and/or functions of each unit in the terminal device 400 are respectively configured to realize the corresponding flow of the terminal device in each method in FIG. 1 to FIG. 4, which is not repeated here for brevity.

Therefore, when only part of synchronization rasters correspond to SSBs in a frequency range, the terminal device in the embodiment of the present application can determine a position of a synchronization raster corresponding to another SSB or a position of a channel bandwidth where the synchronization raster is located according to position indication information in one SSB received, thereby increasing the frequency range of a position of an SSB indicated and reducing the complexity of detecting an SSB by the terminal device.

As shown in FIG. 6, the network device 500 according to an embodiment of the present application includes: a processing unit 510 and a transceiving unit 520. Specifically, the processing unit 510 is configured to generate a first synchronization signal block, and the transceiving unit 520 is configured to transmit the first synchronization signal block, where the first synchronization signal block includes first position indication information, the first position indication information is used for a terminal device to determine a position of a second synchronization raster corresponding to a second synchronization signal block in a target synchronization raster set, and the position of the second synchronization raster is used for the terminal device to determine a frequency position of the second synchronization signal block, and the target synchronization raster set includes part of synchronization rasters in a frequency domain.

In an embodiment, the frequency domain is an unlicensed frequency domain.

In an embodiment, positions of synchronization rasters in the target synchronization raster set and indexes are in a one-to-one correspondence, the first position indication information indicates a first offset, and the first offset is a difference between an index of the second synchronization raster and an index of a first synchronization raster, and the first synchronization raster corresponds to the first synchronization signal block.

In an embodiment, the first position indication information indicates a second offset, the second offset indicates the number of synchronization rasters belonging to the target synchronization raster set between the position of the second synchronization raster and a position of a first synchronization raster, and an offset direction of the position of the second synchronization raster relative to the position of the first synchronization raster, and the first synchronization raster corresponds to the first synchronization signal block.

In an embodiment, the frequency domain includes multiple channel bandwidths, a frequency position of a first channel bandwidth where a first synchronization raster is located is different from a frequency position of a second channel bandwidth where the second synchronization raster is located, and the first synchronization raster corresponds to the first synchronization signal block, where the first position indication information indicates a third offset, and the third offset is the offset between the first channel and the second channel.

In an embodiment, the multiple channel bandwidths are equal.

In an embodiment, the third offset indicates a number of channel bandwidths between the frequency position of the first channel bandwidth and the frequency position of the second channel bandwidth, and an offset direction of the frequency position of the first channel bandwidth relative to the frequency position of the second channel bandwidth.

In an embodiment, the target synchronization raster set includes a first synchronization raster corresponding to the first synchronization signal block.

In an embodiment, the first synchronization signal block further includes first association information, and the first association information is used for indicating that the first synchronization signal block is not associated with remaining minimum system information RMSI.

In an embodiment, a position of the first synchronization raster is a central frequency of the first synchronization signal block, and a position of the second synchronization raster is a central frequency of the second synchronization signal block.

It should be understood that the network device 500 according to the embodiment of the present application can correspond to the execution of the method 300 in the embodiment of the present application, and the above and other operations and/or functions of each unit in the network device 500 are respectively configured to realize the corresponding flow of the network device in each method in FIG. 1 to FIG. 4, which is not repeated here for brevity.

Therefore, when only part of synchronization rasters correspond to SSBs in a frequency range, by transmitting position indication information in one SSB, the network device in the embodiment of the present application can indicate a position of a synchronization raster corresponding to another SSB or a position of a channel bandwidth where the synchronization raster is located, thereby increasing the frequency range of a position of an SSB indicated and reducing the complexity of detecting an SSB by the terminal device.

FIG. 7 is a schematic structural diagram of a communication device 600 provided by an embodiment of the present application. The communication device 600 shown in FIG. 7 includes a processor 610, and the processor 610 can call and run a computer program from a memory to realize the method in the embodiment of the present application.

In an embodiment, as shown in FIG. 7, the communication device 600 may further include a memory 620. The processor 610 can call and run a computer program from the memory 620 to realize the method in the embodiment of the present application.

The memory 620 may be a separate device independent of the processor 610, or may be integrated in the processor 610.

In an embodiment, as shown in FIG. 7, the communication device 600 may further include a transceiver 630, and the processor 610 may control the transceiver 630 to communicate with other devices, specifically, it may transmit information or data to other devices, or receive information or data transmitted by other devices.

The transceiver 630 may include a transmitter and a receiver. The transceiver 630 may further include antennas, and the number of antennas may be one or more.

In an embodiment, the communication device 600 can be specifically a network device in the embodiments of the present application, and the communication device 600 can realize the corresponding processes implemented by the network device in various methods of the embodiments of the present application, which is not repeated here for brevity.

In an embodiment, the communication device 600 can be specifically a mobile terminal/terminal device in the embodiments of the present application, and the communication device 600 can realize the corresponding processes implemented by the mobile terminal/terminal device in various methods of the embodiments of the present application, which is not repeated here for brevity.

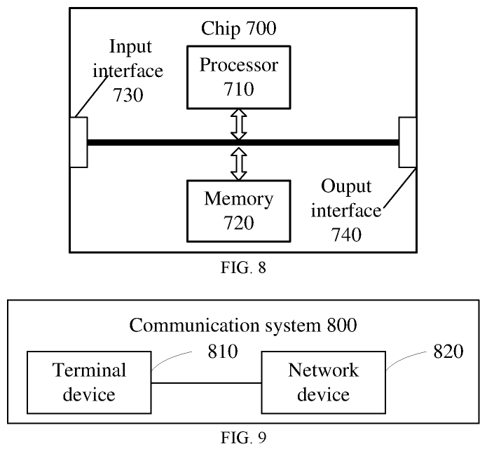

FIG. 8 is a schematic structural diagram of a chip according to an embodiment of the present application. The chip 700 shown in FIG. 8 includes a processor 710, and the processor 710 can call and run a computer program from a memory to realize the method in the embodiment of the present application.

In an embodiment, as shown in FIG. 8, the chip 700 may further include a memory 720. The processor 710 can call and run a computer program from the memory 720 to realize the method in the embodiment of the present application.

The memory 720 may be a separate device independent of the processor 710, or may be integrated in the processor 710.

In an embodiment, the chip 700 may further include an input interface 730. The processor 710 can control the input interface 730 to communicate with other devices or chips, specifically, it can acquire information or data transmitted by other devices or chips.

In an embodiment, the chip 700 may further include an output interface 740. The processor 710 can control the output interface 740 to communicate with other devices or chips, specifically, it can output information or data to other devices or chips.

In an embodiment, the chip can be applied to the network device in the embodiments of the present application, and the chip can realize the corresponding flow implemented by the network device in each method of the embodiments of the present application, which is not repeated here for brevity.

In an embodiment, the chip can be applied to the mobile terminal/terminal device in the embodiment of the present application, and the chip can realize the corresponding flow implemented by the mobile terminal/terminal device in each method of the embodiments of the present application, which is not repeated here for brevity.

It should be understood that the chip mentioned in the embodiments of the present application can also be called a system-level chip, a system chip, a chip system or a system-on-chip chip, etc.

FIG. 9 is a schematic block diagram of a communication system 800 provided by an embodiment of the present application. As shown in FIG. 9, the communication system 800 includes a terminal device 810 and a network device 820.

Among them, the terminal device 810 can be configured to realize the corresponding functions implemented by the terminal device in the above-mentioned method, and the network device 820 can be configured to realize the corresponding functions implemented by the network device in the above-mentioned method, which is not repeated here for brevity.

It should be understood that the processor in the embodiments of the present application may be an integrated circuit chip with signal processing capability. In the implementation process, each step of the above method embodiment can be completed by hardware integrated logic circuits or software instructions in the processor. The above processor can be a general processor, a digital signal processor (DSP), an application specific integrated circuit (ASIC), a field programmable gate array (FPGA) or other programmable logic devices, discrete gate or transistor logic devices, and discrete hardware components. The methods, steps and logic blocks disclosed in the embodiments of the present application can be realized or executed. The general processor can be a microprocessor or the processor can be any conventional processor, etc. The steps of the method disclosed in the embodiments of the present application can be directly embodied as the completion of execution by a hardware decoding processor, or the completion of execution by a combination of hardware and software modules in the decoding processor. Software modules can be located in a random access memory, a flash memory, a read-only memory, a programmable read-only memory or an electrically erasable programmable memory, a register or other mature storage medium in this field. The storage medium is located in the memory, and the processor reads the information in the memory and combines its hardware to complete the steps of the above method.

It should be understood that in the embodiments of the present application, the memory may be either a volatile memory or a non-volatile memory, or may include both volatile and non-volatile memory. Where the non-volatile memory may be a read-only memory (ROM), a programmable read-only memory (PROM), an erasable read-only memory (EPROM), an electrically erasable read-only memory (EEPROM) or a flash memory. The volatile memory may be a random access memory (RAM), which acts as an external cache memory. By way of examples rather than restrictive illustrations, many forms of RAM are available, such as a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM) and a direct rambus random access memory (DR RAM). It should be noted that the memory of the systems and methods described herein is intended to include, without being limited to, these and any other suitable types of memory.

It should be understood that the above memories are exemplary but not restrictive illustrations, for example, the memory in the embodiments of the present invention may also be a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchronous link dynamic random access memory (SLDRAM), a direct rambus random access memory (DR RAM), and the like. That is, the memory of the systems and methods described herein is intended to include, without being limited to, these and any other suitable types of memory.

An embodiment of the present application also provides a computer-readable storage medium for storing computer programs.

In an embodiment, the computer-readable storage medium can be applied to the network device in the embodiments of the present application, and the computer program enables a computer to execute the corresponding flow implemented by the network device in each method of the embodiments of the present application, which is not repeated here for brevity.

In an embodiment, the computer-readable storage medium can be applied to the mobile terminal/terminal device in the embodiments of the present application, and the computer program enables a computer to execute the corresponding flow implemented by the mobile terminal/terminal device in each method of the embodiments of the present application, which is not repeated here for brevity.

An embodiment of the present application also provides a computer program product, including computer program instructions.

In an embodiment, the computer program product can be applied to the network device in the embodiments of the present application, and the computer program instructions enable a computer to execute the corresponding processes implemented by the network device in each method of the embodiments of the present application, which are not repeated here for brevity.

In an embodiment, the computer program product can be applied to the mobile terminal/terminal device in the embodiments of the present application, and the computer program instructions enable a computer to execute the corresponding flow implemented by the mobile terminal/terminal device in each method of the embodiment of the present application, which is not repeated here for brevity.

An embodiment of the present application also provides a computer program.

In an embodiment, the computer program can be applied to the network device in the embodiments of the present application, and when the computer program is run on a computer, it causes the computer to execute the corresponding flow implemented by the network device in each method of the embodiments of the present application, which is not repeated here for brevity.

In an embodiment, the computer program can be applied to the mobile terminal/terminal device in the embodiments of the present application, and when the computer program is run on a computer, it causes the computer to execute the corresponding flow implemented by the mobile terminal/terminal device in each method of the embodiments of the present application, which is not repeated here for brevity.

A person with ordinary skill in the art will appreciate that the various illustrative elements and algorithm steps described in connection with the embodiments disclosed herein may be implemented as the electronic hardware or a combination of the computer software and the electronic hardware. Whether such functionality is implemented as the hardware or the software depends upon the particular application and design constraints imposed on the implementation. A person professionally skilled may implement the described functionality in varying ways for each particular application, but such implementations should not be interpreted as causing a departure from the scope of the present application.

It is clear to a person with ordinary skill in the art that, for convenience and brevity of description, for the specific working processes of the above-described systems, devices and units, reference may be made to the corresponding processes in the foregoing embodiments of the method, which will not be described herein again.

In several embodiments provided in the present application, it should be understood that the disclosed system, device, and method may be implemented in other ways. For example, the above-described embodiments of the device are merely illustrative, and for example, the division of the units is only a logical division, and there may be other divisions in actual implementations, for example, a plurality of units or components may be combined or integrated into another system, or some features may be omitted, or not executed. In addition, the shown or discussed mutual coupling or direct coupling or communication connection may be an indirect coupling or communication connection through some interfaces, devices or units, and may be in an electrical, mechanical or in other forms.

The units described as separate parts may or may not be physically separated, and parts displayed as units may or may not be physical units, may be located in one place, or may be distributed on a plurality of network units. Some or all of the elements may be selected according to actual needs to achieve the objectives of the embodiments of the present application.

In addition, functional units in the embodiments of the present application may be integrated into one processing unit, or each unit may exist alone physically, or two or more units are integrated into one unit.

If the functionality is implemented in the form of software functional units and sold or used as a stand-alone product, it may be stored in a computer readable storage medium. Based on such understanding, the technical solutions of the embodiments of the present application may be embodied in the form of a software product, which is stored in a storage medium and includes several instructions for causing a computer device (which may be a personal computer, a server, or a network device) to execute all or part of the steps of the method described in the embodiments of the present application. The aforementioned storage medium includes: a U disk, a removable hard disk, a ROM, a RAM, a magnetic disk or optical disk, etc. for storing program codes.

The above descriptions are only specific implementations of the present application, but the scope of protection of the present application is not limited thereto, and any person skilled in the art can easily conceive of changes or substitutions within the technical scope of the present application, and all such changes or substitutions should be covered by the scope of protection of the present application. Therefore, the scope of protection of the present application shall be subject to the scope of protection of the claims.

What is claimed is:

1. A method for determining a synchronization signal block, comprising:
receiving a first synchronization signal block, wherein the first synchronization signal block comprises first position indication information, the first position indication information is used for determining a position of a second synchronization raster in a target synchronization raster set, and the target synchronization raster set comprises part of synchronization rasters in a frequency domain;
determining a frequency position of a second synchronization signal block corresponding to the second synchronization raster according to the position of the second synchronization raster.

2. The method according to claim 1, wherein the frequency domain is an unlicensed frequency domain.

3. The method according to claim 1, wherein positions of synchronization rasters in the target synchronization raster set and indexes are in a one-to-one correspondence, the first position indication information indicates a first offset, and the first offset is a difference between an index of the second synchronization raster and an index of a first synchronization raster, and the first synchronization raster corresponds to the first synchronization signal block;
wherein the method further comprises:
determining a sum of an index corresponding to a position of the first synchronization raster and the first offset as the index of the second synchronization raster;
determining the position of the second synchronization raster according to the index of the second synchronization raster.

4. The method according to claim 1, wherein the first position indication information indicates a second offset, the second offset indicates the number of synchronization rasters belonging to the target synchronization raster set between the position of the second synchronization raster and a position of a first synchronization raster, and an offset direction of the position of the second synchronization raster relative to the position of the first synchronization raster, and the first synchronization raster corresponds to the first synchronization signal block;
wherein the method further comprises:
determining the position of the second synchronization raster according to the position of the first synchronization raster and the second offset.

5. The method according to claim 1, wherein the first synchronization signal block further comprises first association information, and the first association information is used for indicating that the first synchronization signal block is not associated with remaining minimum system information (RMSI).

6. The method according to claim 3, wherein the position of the first synchronization raster is a central frequency of the first synchronization signal block, and a position of the second synchronization raster is a central frequency of the second synchronization signal block.

7. A method for determining a synchronization signal block, comprising:
transmitting a first synchronization signal block, wherein the first synchronization signal block comprises first position indication information, the first position indication information is used for a terminal device to determine a position of a second synchronization raster corresponding to a second synchronization signal block in a target synchronization raster set, and the position of the second synchronization raster is used for the terminal device to determine a frequency position of the second synchronization signal block,
wherein the target synchronization raster set comprises part of synchronization rasters in a frequency domain.

8. The method according to claim 7, wherein positions of synchronization rasters in the target synchronization raster set and indexes are in a one-to-one correspondence, the first position indication information indicates a first offset, and the first offset is a difference between an index of the second synchronization raster and an index of a first synchronization raster, and the first synchronization raster corresponds to the first synchronization signal block.

9. The method according to claim 7, wherein the first position indication information indicates a second offset, the second offset indicates the number of synchronization rasters belonging to the target synchronization raster set between the position of the second synchronization raster and a position of a first synchronization raster, and an offset direction of the position of the second synchronization raster relative to the position of the first synchronization raster, and the first synchronization raster corresponds to the first synchronization signal block.

10. The method according to claim 7, wherein the first synchronization signal block further comprises first association information, and the first association information is used for indicating that the first synchronization signal block is not associated with remaining minimum system information (RMSI).

11. A terminal device, comprising:
at least one processor;
a memory connected with the at least one processor; wherein
a computer program, when executed by the at least one processor, causes the at least one processor to:
control an input interface to receive a first synchronization signal block, wherein the first synchronization signal block comprises first position indication information, the first position indication information is used for determining a position of a second synchronization raster in a target synchronization raster set, and the target synchronization raster set comprises part of synchronization rasters in a frequency domain;
determine a frequency position of a second synchronization signal block corresponding to the second synchronization raster according to the position of the second synchronization raster.

12. The terminal device according to claim 11, wherein positions of synchronization rasters in the target synchronization raster set and indexes are in a one-to-one correspondence, the first position indication information indicates a first offset, and the first offset is a difference between an index of the second synchronization raster and an index of a first synchronization raster, and the first synchronization raster corresponds to the first synchronization signal block;
wherein the computer program further causes the at least one processor to:
determine a sum of an index corresponding to a position of the first synchronization raster and the first offset as the index of the second synchronization raster;
determine the position of the second synchronization raster according to the index of the second synchronization raster.

13. The terminal device according to claim 11, wherein the first position indication information indicates a second offset, the second offset indicates the number of synchronization rasters belonging to the target synchronization raster set between the position of the second synchronization raster and a position of a first synchronization raster, and an offset direction of the position of the second synchronization raster relative to the position of the first synchronization raster, and the first synchronization raster corresponds to the first synchronization signal block;
wherein the computer program further causes the at least one processor to:
determine the position of the second synchronization raster according to the position of the first synchronization raster and the second offset.

14. The terminal device according to claim 11, wherein the first synchronization signal block further comprises first association information, and the first association information is used for indicating that the first synchronization signal block is not associated with remaining minimum system information (RMSI).

15. A network device, comprising:
at least one processor;
a memory connected with the at least one processor; wherein
a computer program, when executed by the at least one processor, causes the at least one processor to:
control an output interface to transmit a first synchronization signal block, wherein the first synchronization signal block comprises first position indication information, the first position indication information is used for a terminal device to determine a position of a second synchronization raster corresponding to a second synchronization signal block in a target synchronization raster set, and the position of the second synchronization raster is used for the terminal device to determine a frequency position of the second synchronization signal block,
wherein the target synchronization raster set comprises part of synchronization rasters in a frequency domain.

16. The network device according to claim 15, wherein the frequency domain is an unlicensed frequency domain.

17. The network device according to claim 15, wherein positions of synchronization rasters in the target synchronization raster set and indexes are in a one-to-one correspondence, the first position indication information indicates a first offset, and the first offset is a difference between an index of the second synchronization raster and an index of a first synchronization raster, and the first synchronization raster corresponds to the first synchronization signal block.

18. The network device according to claim 15, wherein the first position indication information indicates a second offset, the second offset indicates the number of synchronization rasters belonging to the target synchronization raster set between the position of the second synchronization raster and a position of a first synchronization raster, and an offset direction of the position of the second synchronization raster relative to the position of the first synchronization raster, and the first synchronization raster corresponds to the first synchronization signal block.

19. The network device according to claim 15, wherein the first synchronization signal block further comprises first association information, and the first association information is used for indicating that the first synchronization signal block is not associated with remaining minimum system information (RMSI).

20. The network device according to claim 17, wherein a position of the first synchronization raster is a central frequency of the first synchronization signal block, and a position of the second synchronization raster is a central frequency of the second synchronization signal block.
